(19) United States
(12) Patent Application Publication
(10) Pub. No.: US 2023/0282816 A1
(43) Pub. Date: Sep. 7, 2023

(54) INDIUM ZINC-BASED ALLOY ANODES FORMING POROUS STRUCTURE FOR AQUEOUS ZINC BATTERIES

(71) Applicant: Battelle Memorial Institute, Richland, WA (US)

(72) Inventors: Matthew R. Fayette, Richland, WA (US); Xiaolin Li, Richland, WA (US); David M. Reed, Richland, WA (US)

(73) Assignee: Battelle Memorial Institute, Richland, WA (US)

(21) Appl. No.: 18/177,586

(22) Filed: Mar. 2, 2023

Related U.S. Application Data
(60) Provisional application No. 63/316,578, filed on Mar. 4, 2022.

(51) Int. Cl. H01M 4/42; H01M 4/04; H01M 10/36; H01M 4/60

(52) U.S. Cl. CPC H01M 4/42; H01M 4/0404; H01M 10/36; H01M 4/0452; H01M 4/60; H01M 2004/027

(57) ABSTRACT

Indium zinc-based alloy anodes include an InₓM_{y}Zn_{z} alloy, where x ranges from 0.03 to 0.20, z ranges from 0.80 to 0.97, and x+y+z=1 when the anode has not previously been cycled. M is Al, Ag, Bi, Sn, Cd, or any combination thereof. In a partially or fully discharged state after one or more cycles, the anode includes a porous surface portion enriched in indium and a bulk portion comprising the InₓM_{y}Zn_{z} alloy. In a subsequent partially or fully charged state, the pores may be at least partially filled with zinc.

### CROSS REFERENCE TO RELATED APPLICATION

This application claims the benefit of the earlier filing date of U.S. Provisional Application No. 63/316,578, filed Mar. 4, 2022, which is incorporated by reference in its entirety herein.

### ACKNOWLEDGMENT OF GOVERNMENT SUPPORT

This invention was made with government support under Contract DE-AC0576RL01830 awarded by the U.S. Department of Energy. The government has certain rights in the invention.

### FIELD

This disclosure concerns indium zinc-based alloy anodes for aqueous zinc batteries.

### BACKGROUND

Aqueous zinc batteries use earth abundant elements and have high safety, low-cost, and established recyclability. Zinc based batteries (e.g. MnO₂/Zn) have been commercialized as a primary battery and are one of the dominant technologies in the battery market; however, the rechargeability of MnO₂/Zn and other zinc-based batteries is severely limited by zinc anode challenges, particularly under conditions of high depth of discharge and/or high plating current densities. Zinc dendrite formation, resulting in an internal short-circuit, is the most prevalent cause of cell failure for aqueous zinc batteries with a non-alkaline electrolyte. There is a need for zinc anodes with mitigated dendrite formation during cycling.

### SUMMARY

Anodes for aqueous zinc batteries are disclosed. Batteries including the anodes, and methods of making and using the anodes also are disclosed.

Implementations of the disclosed anodes comprise an InₓM_{y}Zn_{z} alloy, where M is Al, Ag, Bi, Pb, Sn, Cd, or any combination thereof. In some implementations, M is Al. In some aspects, when the anode has not been previously cycled the following apply: x ranges from 0.03 to 0.2, z ranges from 0.80 to 0.97, and x+y+z=1, the anode comprises indium domains and zinc domains distributed throughout the InₓM_{y}Zn_{z} alloy, and an exposed upper surface of the anode has a zinc concentration ≥z. It is understood that values of x, y, and z also correspond to the atomic percent of each element in the alloy. For example, a value of x=0.08 corresponds to 8 at % indium. Thus, an indium-aluminum-zinc alloy having a composition In_{0.1}Al_{0.01}Zn_{0.89} includes 10 at % indium, 1 at % aluminum, and 89 at % zinc.

In some aspects, the anode further includes a current collector. In certain implementations, the anode further comprises a zinc layer in contact with the current collector, the zinc layer having a thickness ranging from 0.5 μm to 1 μm, and/or a concentration of indium in a lower region of the InₓM_{y}Zn_{z} alloy proximal to the current collector is >x.

In any of the foregoing or following aspects, in a partially or fully discharged state after one or more cycles, the anode may include a porous surface portion comprising a plurality of pores, the porous surface portion having an indium concentration greater than x at % and a zinc concentration less than z at %, and a bulk portion comprising the InₓM_{y}Zn_{z} alloy. In a fully discharged state, the porous surface portion may comprise at least 50 at % indium. In some implementations, at least some indium in the porous surface portion is present as In₂O₃.

In any of the foregoing or following aspects, pores of the porous surface portion are at least partially filled with zinc when the anode is subsequently in a partially or fully charged state. In some aspects, a morphology of the indium in the porous surface portion remains static as pores fill with zinc during a charging process and empty during a subsequent discharging process.

Aspects of a rechargeable zinc cell include an anode as disclosed herein, a cathode, and an aqueous electrolyte. The aqueous electrolyte comprises a zinc salt, and may comprise one or more additives. In some implementations, the aqueous electrolyte comprises ZnSO₄, Zn(H₂NSO₃)₂, Zn(CH₃SO₃)₂, Zn(C₂F₆NO₄S₂)₂, Zn(F₂NO₄S₂)₂, Zn(ClO₄)₂, and Zn(CH₃CO₂)₂, or any combination thereof.

Aspects of the disclosed anodes may be formed by preparing a film comprising the InₓM_{y}Zn_{z} alloy via electrodeposition from an aqueous solution comprising In³⁺ ions and Zn²⁺ ions in an In:Zn molar ratio of x:z. The film may be electrodeposited onto a current collector.

The foregoing and other objects, features, and advantages of the disclosure will become more apparent from the following detailed description, which proceeds with reference to the accompanying figures.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIGS. 1A-1C are diagrams showing desirable anode attributes of zinc (FIG. 1A), indium (FIG. 1B), and aluminum (FIG. 1C).

FIGS. 2A and 2B are X-ray diffraction (XRD) spectra of AlZn deposited onto copper (FIG. 2A) and InZn deposited onto brass (FIG. 2B).

FIGS. 3A-3D show scanning electron microscope (SEM) images of uncycled AlZn on Cu (FIG. 3A) and uncycled InZn on brass (FIG. 3B), and energy dispersive spectroscopy (EDS) mapping showing zinc and aluminum on the AlZn surface (FIG. 3C) and zinc, indium, and aluminum on the InZn surface (FIG. 3D).

FIGS. 4A-4C show an XRD spectrum (FIG. 4A) and an SEM image (FIG. 4B) of pristine commercial zinc foil, and an SEM image (FIG. 4C) of the zinc foil after a first discharge cycle of a zinc foil anode.

FIGS. 5A-5D show SEM images obtained from analyzing cycled AlZn on Cu (FIG. 5A) and InZn on brass (FIG. 5B), and EDS mapping showing zinc and aluminum on the AlZn surface (FIG. 5C) and zinc and indium on the InZn surface (FIG. 5D).

FIGS. 6A-6D show SEM images obtained from analyzing uncycled InAlZn including 2 at % In (FIG. 6A), cycled InAlZn including 2 at % In (FIG. 6B), and EDS mapping of uncycled InZn including 2 at % In (FIG. 6C) and cycled InZn including 2 at % In (FIG. 6D).

FIGS. 7A-7F show cross-section SEM images obtained from analyzing uncycled InAlZn (2.3:1 Zn:In) (FIG. 7A), InAlZn (8.3:1 Zn:In) (FIG. 7B), and InAlZn (10:1 Zn:In) (FIG. 7C), and corresponding EDS mapping showing zinc, indium, and aluminum on the InAlZn surfaces (FIGS. 7D-7F).

FIGS. 8A and 8B show SEM images obtained from analyzing cycled InZn (FIG. 8A) and energy dispersive X-ray (EDX) mapping (FIG. 8B) of the cycled InZn, wherein the inset of FIG. 8B shows oxygen distribution along the InZn surface.

FIGS. 9A-9C are graphs showing cycling of commercial zinc foil anode (FIG. 9A), an AlZn/Cu anode (FIG. 9B), and an InZn/brass anode (FIG. 9C), each cycled at a current density of 1 mA cm⁻² with a corresponding charge of 5 mAh cm⁻².

FIGS. 10A-10C are graphs showing cycling of commercial zinc foil (FIG. 10A), an AlZn/Cu (FIG. 10B) anode, and an InZn/brass anode (FIG. 10C), each cycled at a current density of 10 mA cm⁻² with a corresponding charge of 5 mAh cm⁻².

FIGS. 11A and 11B are graphs showing cycling of InZn anodes including greater than 15 at % indium (FIG. 11A) or less than 5 at % indium (FIG. 11B) cycled at a current density of 10 mA cm⁻² with a corresponding charge of 5 mAh cm⁻².

FIGS. 12A and 12B are graphs showing a first full cycle charge/discharge curve for a full cell with a zinc foil anode and a dibenzo[b,i]thianthrene-5,7,12,14-tetraone (DTT) cathode using a current density of 100 mA g⁻¹ (FIG. 12A) and long term cyclability of full DTT cells with zinc foil, AlZn, or InZn anodes using a current density of 100 mA g⁻¹ (FIG. 12B); wherein all cells included an aqueous 2 M ZnSO₄ electrolyte.

FIGS. 13A and 13B are SEM images obtained from analyzing a pristine (FIG. 13A) and cycled (FIG. 13B) zinc powder electrode.

### DETAILED DESCRIPTION

Anodes for aqueous zinc batteries are disclosed. In some aspects, the anode comprises an InₓM_{y}Zn_{z} alloy, wherein M is Al, Ag, Bi, Pb, Sn, Cd, or any combination thereof. When the anode has not been previously cycled, x ranges from 0.03 to 0.20, z ranges from 0.80 to 0.97, and x+y+z=1. Batteries including the anodes, and methods of making and using the anodes also are disclosed.

### I. Definitions and Abbreviations

The following explanations of terms and abbreviations are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more elements, unless the context clearly indicates otherwise.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Other features of the disclosure are apparent from the following detailed description and the claims.

The disclosure of numerical ranges should be understood as referring to each discrete point within the range, inclusive of endpoints, unless otherwise noted. Unless otherwise indicated, all numbers expressing quantities of components, molecular weights, percentages, temperatures, times, and so forth, as used in the specification or claims are to be understood as being modified by the term “about.” Accordingly, unless otherwise implicitly or explicitly indicated, or unless the context is properly understood by a person of ordinary skill in the art to have a more definitive construction, the numerical parameters set forth are approximations that may depend on the desired properties sought and/or limits of detection under standard test conditions/methods as known to those of ordinary skill in the art. When directly and explicitly distinguishing embodiments from discussed prior art, the embodiment numbers are not approximates unless the word “about” is recited.

Although there are alternatives for various components, parameters, operating conditions, etc. set forth herein, that does not mean that those alternatives are necessarily equivalent and/or perform equally well. Nor does it mean that the alternatives are listed in a preferred order unless stated otherwise.

Definitions of common terms in chemistry may be found in Richard J. Lewis, Sr. (ed.), Hawley's Condensed Chemical Dictionary, published by John Wiley & Sons, Inc., 2016 (ISBN 978-1-118-13515-0). In order to facilitate review of the various embodiments of the disclosure, the following explanations of specific terms are provided:

Alloy: As used herein, the term “alloy” refers to a solid mixture of two or more metals. The alloy may be a heterogeneous mixture, including dispersed domains or regions comprising a single metal.

Anode: An electrode through which electric charge flows into a polarized electrical device. From an electrochemical point of view, negatively-charged anions move toward the anode and/or positively-charged cations move away from it to balance the electrons leaving via external circuitry.

Cathode: An electrode through which electric charge flows out of a polarized electrical device. From an electrochemical point of view, positively charged cations invariably move toward the cathode and/or negatively charged anions move away from it to balance the electrons arriving from external circuitry.

Cell: As used herein, a cell refers to an electrochemical device used for generating a voltage or current from a chemical reaction, or the reverse in which a chemical reaction is induced by a current. A battery includes one or more cells. The terms “cell” and “battery” are used interchangeably when referring to a battery containing only one cell.

Current collector: A battery component that conducts the flow of electrons between an electrode and a battery terminal. The current collector also may provide mechanical support for the electrode's active material.

Electrolyte: A substance containing free ions that behaves as an electrically conductive medium. Electrolytes generally comprise ions in a solution.

Polarization: A change in electrode potential resulting from passage of current across an electrode-to-electrolyte interface.

Pore: One of many openings or void spaces in a solid substance.

### II. InZn-Based Alloy Anode

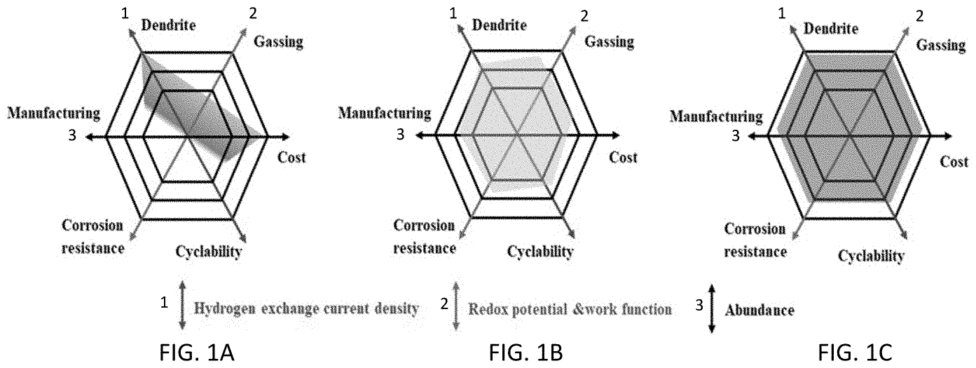

Desirably, an anode for an aqueous zinc battery will provide (i) mitigation of zinc dendrite formation/good cycling performance, (2) enhanced tolerance of zinc to corrosion/gassing, (3) usage of earth abundant elements, and/or (4) excellent manufacturability with an economic/scalable approach. FIGS. 1A-1C show certain desirable anode attributes of zinc, indium, and aluminum (e.g., gassing, dendrite, manufacturing, cyclability, cost, and/or corrosion resistance) and their determining physicochemical properties, including hydrogen exchange current density (HECD), redox potential, and/or abundance. The exchange current density is the measured current when no potential is applied to an electrode material for a given electrochemical reaction (e.g., hydrogen evolution); low HECD can reflect high overpotentials for the hydrogen evolution reaction. FIG. 1A shows that zinc foil satisfies two criteria: low cost and manufacturability but falls well short of the other parameters.

In some aspects of the present disclosure, an anode for a zinc aqueous battery is disclosed, which comprises an InₓM_{y}Zn_{z} alloy where x+y+z=1, and M is Al, Ag, Bi, Pb, Sn, Cd, or any combination thereof. It is to be understood that values of x, y, and z also correspond to the atomic percent of each element in the alloy. For example, a value of x=0.08 corresponds to 8 at % indium. Thus, an indium-aluminum-zinc alloy having a composition In_{0.1}Al_{0.01}Zn_{0.89} includes 10 at % indium, 1 at % aluminum, and 89 at % zinc.

In some implementations, M is a single metal. For example, M may be Al. When M is Al, the alloy has a formula InₓAl_{y}Zn_{z}. In certain aspects, M is a combination of Al and one or more additional metals M, where the other metal(s) are Ag, Bi, Pb, Sn, Cd, or any combination thereof. When the alloy comprises Al plus one additional metal M (where M is Ag, Bi, Pb, Sn, or Cd), the alloy has a formula InₓAl_{y1}M_{y2}Zn_{z}, where y1+y2=y. When the alloy comprises Al plus two additional metals M, the metals M are referred to as M¹ and M², and the alloy has a formula InₓAl_{y1}M¹_{y2}M²_{y3}Zn_{z}, where y1+y2+y3=y. Similarly, when the alloy comprises Al plus three additional metals M, the metals M are referred to as M¹, M² and M³, and the alloy has a formula InₓAl_{y1}M¹_{y2}M²_{y3}M³_{y4}Zn_{z}, where y1+y2+y3+y4=y. Or, when the alloy comprises Al plus four additional metals M, the metals M are referred to as M¹, M², M³ and M⁴, and the alloy has a formula InₓAl_{y1}M¹_{y2}M²_{y3}M³_{y4}M⁴_{y5}Zn_{z}, where y1+y2+y3+y4+y5=y. When the alloy comprises Al plus five additional metals M, the metals M are referred to as M¹, M², M³, M⁴, and M⁵ and the alloy has a formula InₓAl_{y1}M¹_{y2}M²_{y3}M³_{y4}M⁴_{y5}M⁵_{y6}Zn_{z}, where y1+y2+y3+y4+y5+y6=y.

Bonding between In/Zn results in a positive shift of the dissolution potential of the less noble metal and facilitates removal of the less noble component (Zn) (Erlebacher, Nature 2001, 410:450-453; Xia et al., Materials Research Bulletin 2017, 85:1-9; Aiello et al., JECS 2018, 165(14):C950-C961). Thus, zinc may be preferentially de-alloyed, or removed, from the anode during discharge.

The de-alloyed structure of the disclosed anode is tunable by varying the alloy composition and/or de-alloying conditions. In some aspects, the amount and distribution of indium is controlled to bring another advantage in accommodating and/or suppressing dendrite formation as the remaining metal re-orders itself during the process of zinc removal that occurs during a discharge process and can create a nanoporous structure with higher surface areas compared to an uncycled anode.

In some aspects, an uncycled anode comprises an InₓM_{y}Zn_{z} alloy where x ranges from 0.03 to 0.20, z ranges from 0.80 to 0.97, and wherein x+y+z=1, when the anode has not previously been cycled. As set forth above, M may be a single metal or a combination of metals. In certain aspects, x ranges from 0.05 to 0.15 and z ranges from 0.83 to 0.97. In some implementations, x ranges from 0.08 to 0.15 or 0.08 to 0.12, or x is in a range having endpoints selected from 0.03, 0.04, 0.05, 0.06, 0.07, 0.08, 0.09, 0.10, 0.11, 0.12, 0.13, 0.14, 0.15, 0.16, 0.17, 0.18, 0.19, or 0.20. In certain implementations, z ranges from 0.83 to 0.92 or 0.86 to 0.92, or z is in a range having endpoints selected from 0.80, 0.81, 0.82, 0.83, 0.84, 0.86, 0.87, 0.88, 0.89, 0.90, 0.91, 0.92, 0.93, 0.94, 0.95, 0.96, or 0.97. In any of the foregoing or following aspects, y is ≤0.02, such as 0<y≤0.02 or 0<y≤0.01, or y is in a range having endpoints selected from 0, 0.001, 0.002, 0.004, 0.006, 0.008, 0.010, 0.012, 0.014, 0.016, 0.018, or 0.02.

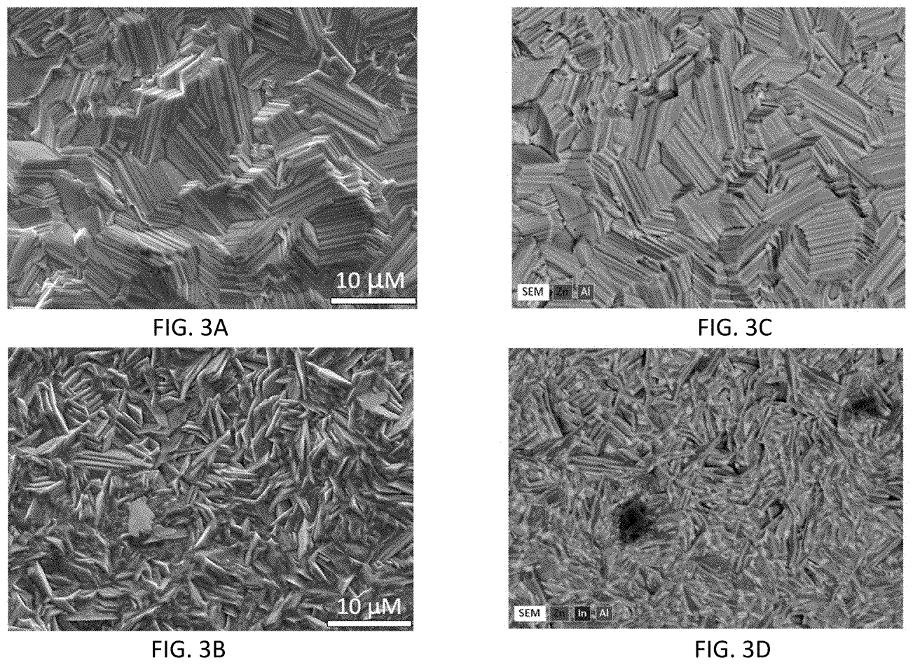

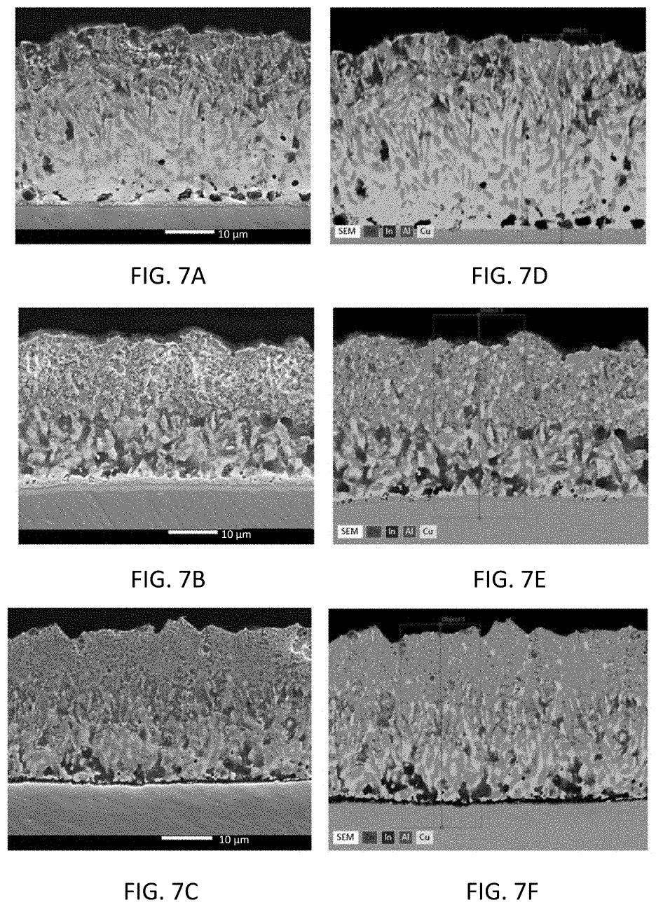

In any of the foregoing or following aspects, prior to cycling the anode, the anode may comprise indium domains and zinc domains distributed throughout the InₓM_{y}Zn_{z} alloy (see, e.g., FIG. 3D, discussed in Example 1). As used herein, the term “domain” refers to a region or area comprising a single metal. Domains may be discrete, contiguous, or a combination of discrete and contiguous domains. In some aspects, at least some of the indium domains are discrete domains that are surrounded by zinc domains. In some implementations, the domain distribution is heterogeneous. For example, an anode electrodeposited onto a current collector may have a thin layer (e.g., ranging from 0.5 μm to 1 μm) consisting of, or comprising primarily of (e.g., at least 95 at %), zinc in contact with the current collector (e.g., such as is shown in FIGS. 7D-7F, Example 1). Subsequently, competitive zinc and indium deposition occurs. Since indium is more favorably deposited, the concentration of indium may be higher in a lower region (proximal to the current collector) of the deposited zinc-rich alloy relative to the overall indium concentration of the alloy (e.g., as shown in FIGS. 7D-7F). Thus, a concentration of indium in the lower region of the anode may be >x. And, a concentration of indium on an upper exposed surface of the uncycled anode may be ≤x, whereas a concentration of zinc on the upper exposed surface may be ≥z. In one example, an anode with a surface indium concentration ranging from 9.5 at % to 12 at % may have a bulk indium concentration ranging from 10 at % to 15 at %. The heterogeneity may be more pronounced at higher indium concentrations (e.g., greater than 15 at %; FIG. 7D) and less pronounced at lower indium concentrations (e.g., less than 15 at %; FIGS. 7E, 7F). The arrangement of indium and zinc domains is not an interdigitated arrangement in which the uncycled anode has an upper indium surface with indium “fingers” extending into a bulk portion comprising zinc. Instead, an upper exposed surface of the uncycled anode includes both indium and zinc, and may be enriched in zinc relative to the bulk of the anode, as discussed above (see, e.g., FIGS. 7E, 7F

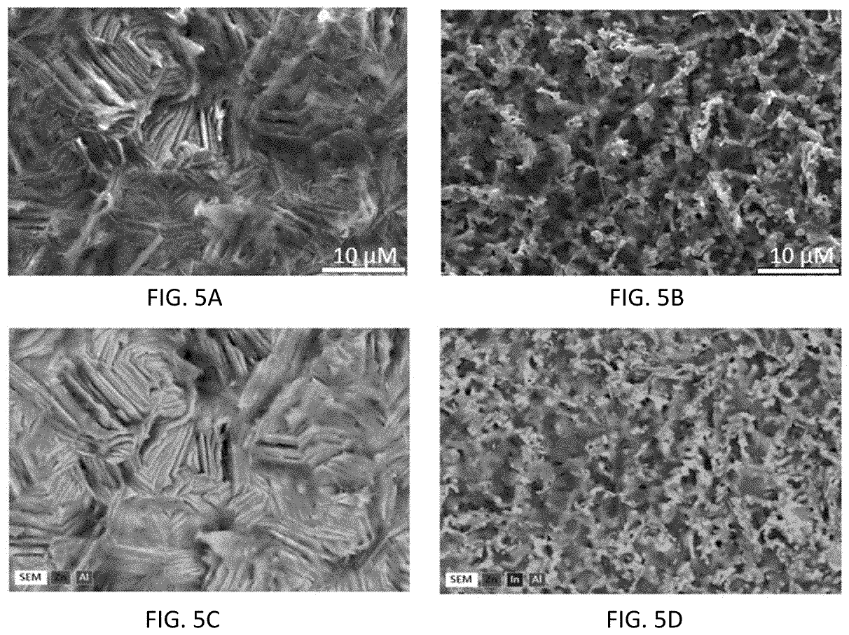

In any of the foregoing or following aspects, in a partially or fully discharged state after one or more cycles, the anode may comprise a porous surface portion comprising (i) a plurality of pores and (ii) a bulk portion comprising the InₓM_{y}Zn_{z} alloy. A porous surface portion comprising the plurality of pores forms as zinc is de-alloyed from the anode during a discharging process. Indium remains in the surface portion as the zinc is de-alloyed and may rearrange into a porous network, thereby forming embodiments that can comprise a porous surface portion having an indium concentration greater than x at % and a zinc concentration less than z at %. If, for example, x is 0.1 (10 at %) when the anode has not previously been cycled, the surface portion has an indium concentration greater than 10 at % when the anode is in a partially or fully discharged state after one or more cycles. Conversely, if z is 0.9 (90 at %) in the uncycled anode, the surface portion has a zinc concentration less than 90 at % when the anode is in a partially or fully discharged state after one or more cycles. The bulk portion may have overall concentrations of indium and zinc that remain substantially unchanged (e.g., the concentrations change less than ±5% relative to the initial concentrations x and z) as the anode is cycled. The porous surface portion may have a sponge-like morphology, e.g., as shown in FIG. 5D (discussed in Example 1), and has an increased surface area compared to the surface area prior to cycling the anode. In any of the foregoing or following aspects, a depth of the porous surface portion may increase as a depth of discharge of the anode increases.

In any of the foregoing or following aspects, at least some of the indium in the porous surface portion may oxidize and be present in the form of In₂O₃. Without wishing to be bound by a particular theory of operation, it currently is believed that oxidation of the indium-enriched surface may stabilize the porous surface morphology.

In some implementations, the porous surface portion comprises at least 50 at % indium when the anode is in a partially or fully discharged state. In certain aspects, the porous surface portion comprises at least 60 at %, at least 65 at %, at least 70 at %, or at least 75 at % indium in the partially or fully discharged state, such as 60 at % to 100 at %, 60 at % to 98 at %, 60 at % to 95 at %, 65 at % to 95 at %, 70 at % to 95 at %, or 75 at % to 95 at % indium. The indium concentration in the surface portion may progressively increase as the anode undergoes a discharging process.

In any of the foregoing or following aspects, pores of the porous surface portion may be at least partially filled with zinc in a subsequent partially or fully charged state. In some implementations, pores in the porous surface portion progressively fill with zinc as the anode undergoes a charging process. In certain aspects, the porous morphology of the indium in the surface portion remains static or essentially static as the pores fill with zinc during the charging process and empty again as the anode is discharged. The static or essentially static morphology may be verified by imaging, such as by scanning electron microscopy imaging, or any other suitable method.

In some aspects, when x is <0.05, fewer or no pores form when the anode is discharged, and the dendrite mitigation provided by the porous surface structure does not occur. For example, when zinc is doped with indium at ˜300 ppm (<1.7 at %), a porous surface structure does not form. In certain aspects, when x>0.015, a surface concentration of indium may not increase concomitantly (for example, a 50% increase in indium content may result in only a 20% increase in the surface indium concentration); however, the increased indium concentration in a bulk portion of the anode results in poor cyclability compared to aspects of the anode where x ranges from 0.05 to 0.15.

Advantageously, some aspects of the disclosed anodes exhibit reduced dendrite formation when cycled compared to AlZn and Zn anodes. In certain implementations, the anodes exhibit no dendrite formation when cycled. The in-situ generated porosity dramatically increases the anode surface area and mitigates dendrite formation by providing surface pores that fill with zinc as the anode is charged. In some aspects, the porosity enhances cycle life without sacrificing capacity.

In any of the foregoing or following aspects, the anode may have (i) a polarization ranging from 5 mV to 45 mV, or (ii) an areal capacity of at least 1 mAh cm⁻², or (iii) an anode specific capacity of at least 500 mAh g⁻¹, or (iv) any combination of two or more of (i), (ii), and (iii). In some aspects, the polarization ranges from 5 mV to 35 mV, or 5 mV to 25 mV. In some aspects, the areal capacity ranges from 1 mAh cm⁻² to 15 mAh cm⁻², such as from 2 mAh cm⁻² to 10 mAh cm⁻², 4 mAh cm⁻² to 6 mAh cm⁻² or 4.5 mAh cm⁻² to 5.5 mAh cm⁻², corresponding to 45% depth of discharge. In some aspects, the anode specific capacity is at least 550 mAh g⁻¹, at least 600 mAh g⁻¹, or at least 700 mAh g⁻¹, such as an anode specific capacity 500 mAh g⁻¹ to 770 mAh g⁻¹, 600 mAh g⁻¹ to 770 mAh g⁻¹, or 700 mAh g⁻¹ to 770 mAh g⁻¹, In certain aspects, the full cell specific capacity ranges from 100 mAh g⁻¹ to 120 mAh g⁻¹, such as from 105 mAh g⁻¹ to 115 mAh g⁻¹. In some implementations, the anode exhibits stability over at least 250, at least 500, at least 600, or even at least 700 cycles. In some examples, InₓM_{y}Zn_{z} alloy anodes (comprising, for example, 8 at % to 15 at % indium) exhibited a low polarization of ˜5 mV to 45 mV and demonstrated stability over 700 cycles at a current density of 10 mA cm⁻² and 45% depth-of-discharge.

In any of the foregoing aspects, the anode may be prepared by electrodeposition or any other suitable method. Advantageously, electrodeposition is cost-efficient compared to high-temperature alloy manufacturing, and may provide high yield, tunability, and/or scalability. In some aspects, the film comprising the InₓM_{y}Zn_{z} alloy is formed by electrodeposition from an aqueous solution comprising In³⁺ ions and Zn²⁺ ions in an In:Zn molar ratio of x:z. The In³⁺ ions and Zn²⁺ ions may be provided by any water-soluble salts of In and Zn. In some implementations, the In³⁺ ions and Zn²⁺ ions are provided by In₂(SO₄)₃ and ZnSO₄, respectively. In some aspects, the aqueous solution further comprises M cations. The M cations may be provided by any water-soluble salt of M. In some implementations, the aqueous solution has an In:M:Zn molar ratio of x:y:z. In certain implementations, the aqueous solution further comprises aluminum sulfate and boric acid. The deposition may be an alloy/metal-matrix deposition, which includes electrodeposition in the presence of particles that are incorporated into the depositing film via convection. For example, Al may be deposited into the alloy by precipitation of Al₂O₃ due to pH shifts during the electrodeposition process. The alloy film may be electrodeposited onto a current collector. In some aspects, as previously discussed, a zinc layer (such as a layer having a thickness ranging from 0.5 μm to 1 μm) consisting of, or comprising primarily, zinc in contact with the current collector may first deposit onto the current collector. Subsequently, competitive zinc and indium deposition occurs. Since indium is more favorably deposited, the concentration of indium may be higher in a lower region (proximal to the current collector) of the deposited zinc-rich alloy relative to the overall indium concentration of the alloy.

### III. Rechargeable Zinc Cells

In some aspects, a rechargeable zinc cell includes an anode as disclosed herein, a cathode, and an aqueous electrolyte. The cell may further include a separator between the anode and cathode.

In any of the foregoing or following aspects, the cathode may be any cathode suitable for use in a zinc cell including an aqueous electrolyte. The cathode may comprise a zinc insertion/intercalation material. In some aspects, the cathode comprises an organic electrode material. Suitable cathode materials include, but are not limited to, quinones, aromatic imides and anhydride imides, imines, metal, metal oxides, metal sulfides, metal organic frameworks (MOFs), Prussian blue, and Prussian blue analogues. In some implementations, the cathode comprises dibenzo[b,i]thianthrene-5,7,12,14-tetraone (DTT), pyrene-4,5,9,10-tetraone (PTO), triangular phenanthrenequinone-based macrocycle (PQ-Δ), tetrachloro-1,4-benzoquinone (p-chloranil), tetraamino-p-benzoquinone (TABQ), 3,4,9,10-perylenetetracarboxylic diimide perylenediimide perylimid (PTCDI), 3,4,9,10-perylenetetracarboxylic dianhydride (PTCDA), phenazine (PXZ), or diquinoxalino [2,3-a:2′,3′-c] phenazine (HATN). Additional suitable organic cathode materials may include polyaniline (PANI), polypyrrole (PPy), poly-thiophene (PTh), poly(3,4-ethylene dioxythiophene) (PEDOT), poly(p-phenylene) (PPP), polyindole (PIn), nitronyl nitroxides, organosulfur polymers, and triphenylamine and its derivatives. Suitable inorganic cathode materials include, but are not limited to, MnO₂, vanadium oxide (VOₓ, e.g., V₂O₃, VO₂, V₂O₅, V₃O₇), ZnₓMn₂₋ₓO₄ where x≤1, MnS, Co₃O₄, Ag, MgV₂O₅, Bi₂S₃, calcium vanadium oxide (CaVO, e.g., CaV₄O₉, Ca_{0.20}V₂O₅, Ca_{0.67}V₈O₂₀, and the like), Mn-based MOFs, Cu-based MOFs, Prussian blue and its analogues. In some examples, the cathode comprises DTT.

In any of the foregoing or following aspects, the cathode may further comprise a current collector, one or more additives, and/or one or more binders. Suitable additives include carbon, such as acetylene black or graphite. Suitable binders include, for example, polytetrafluoroethylene (PTFE), polyvinylidene fluoride (PVDF), carboxymethyl cellulose, and cellulose acetate.

In any of the foregoing or following aspects, the aqueous electrolyte may be any aqueous electrolyte suitable for use with a rechargeable zinc battery. In some aspects, the electrolyte comprises a zinc salt, such as a soluble zinc salt, in water. Suitable zinc salts include, but are not limited to, ZnSO₄, Zn(H₂NSO₃)₂, Zn(CH₃SO₃)₂, Zn(TFSI)₂(Zn(C₂F₆NO₄S₂)₂), Zn(FSI)₂ (Zn(F₂NO₄S₂)₂), Zn(ClO₄)₂, Zn(CH₃CO₂)₂, and combinations thereof. In some implementations, the electrolyte comprises aqueous zinc sulfate, such as 0.5 M to 3.5 M ZnSO₄, 0.5 M to 3 M ZnSO₄, 0.5 M to 2.5 M ZnSO₄, 0.5 M to 2 M ZnSO₄, or 1 M to 2 M ZnSO₄. In any of the foregoing or following aspects, the electrolyte may be mildly acidic (e.g., pH 4-7).

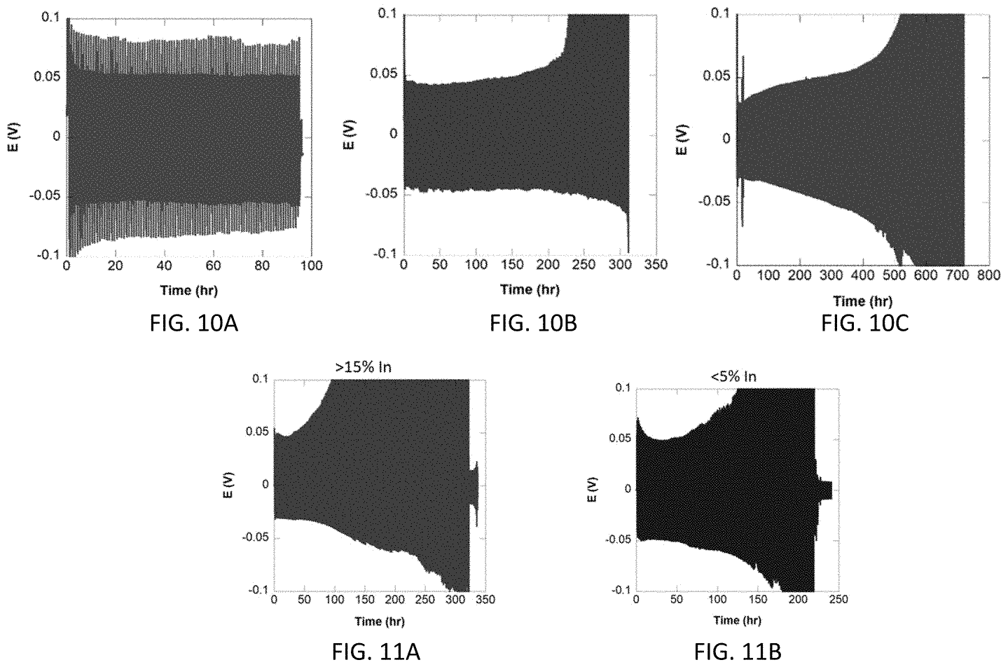

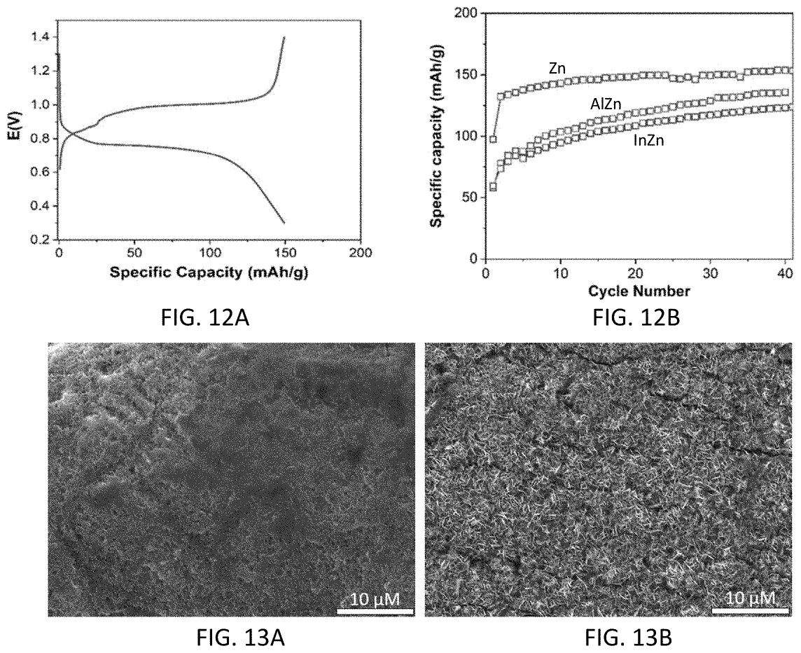

In any of the foregoing or following aspects, the rechargeable zinc battery may have a specific capacity of at least 80 mAh g⁻¹, at least 90 mAh g⁻¹, or at least 100 mAh g⁻¹. In some aspects, the rechargeable zinc battery exhibits stability, as evidenced by a steady or increasing specific capacity over at least 20 cycles, at least 30 cycles, or at least 40 cycles. In one example, full cells with an InₓAl_{y}Zn_{z} anode as disclosed herein, a DTT cathode, and an aqueous 2M ZnSO₄ electrolyte delivered a capacity of ˜110 mAh g⁻¹ with excellent stability over 40 cycles (see, e.g., FIG. 12B, Example 2). In another example, an InₓAl_{y}Zn_{z} anode in a symmetric cell cycled at a current density of 1 mA cm⁻² with a corresponding charge of 5 mAh cm⁻² (correlating to a depth of discharge of 45%) exhibited a cycle life of at least 1000 hours (see, e.g., FIG. 9C, Example 2). At a high current density of 10 mA cm⁻², the InₓAl_{y}Zn_{z} anode demonstrated a long cycle life of over 700 hours (see, e.g., FIG. 10C, Example 2).

### IV. Examples

### Experimental

Copper foil and brass foil (0.254 mm thickness, 99.9% metals basis Alfa Aesar) were used as current collectors for electrodeposition and subsequent symmetric and full cell testing. Brass was chosen as the substrate for InZn as indium is known to diffuse into copper during electrodeposition. The foils were then immersed in 10% sulfuric acid for 10 minutes to clean the surface, followed by soaking in Millipore water, then dried with argon.

The substrate foils were attached to a thick copper cathode (Koncour Company) with platers tape (3 M) for galvanostatic deposition. Zinc anode and platinized titanium sheet anodes were used for the electrodeposition of aluminum-zinc and indium-zinc films, respectively. Aluminum-zinc films were electrodeposited from a solution of 0.6 M ZnSO₄ (99.9% Sigma Aldrich)+30 g/L Al₂(SO₄)₃ (97+% Alfa Aesar), and 0.5 M H₃BO₃ (99.97% Sigma Aldrich). Indium-zinc alloy films were electrodeposited from 0.6 M ZnSO₄+1.5 M Na₂SO₄ (99% Sigma Aldrich)+0.0125 M, 0.025 M, 0.037 M In₂(SO₄)₃ (98% Sigma Aldrich)+0.5 M H₃BO₃+30 g/L Al₂(SO₄)₃, and 0.01 M saccharin (98% Sigma Aldrich) at 50° C. with magnetic stirring (ω=1000 rpm). In order to close the reduction potential gap between indium and zinc (˜0.35V), the molar ratio of zinc to indium was 10:1 in order to ensure a zinc rich alloy. The current densities for deposition of AlZn and InZn alloy anodes were 12.5 mA/cm² and 25 mA/cm² respectively. The target charge for both alloys was 12.5 mAh/cm², leading to deposition times of 60 and 30 minutes. After electrodeposition, all films were thoroughly rinsed with deionized water and dried with argon.

Anode powders of commercial Zinc (90 wt %) were mixed with acetylene black (5 wt %) and 5 wt % of polyvinylidene fluoride (PVDF) followed by planetary ball milling (Retsch PM 100 CM ball mill). The zinc powder film then was rolled onto a carbon-coated copper current collector and dried at 120° C. overnight. The dried anode electrode film was then punched into 0.625-inch diameter disks. The average mass loading of zinc powder anode was approximately 12 mg/cm².

XRD measurements were performed using a Rigaku Miniflex II diffractometer with Cu Kα radiation (2=1.5406 Å). SEM images were performed on a JEOL® JSM-7001F (field emission) scanning electron microscope (SEM) equipped with an Oxford EDX (energy dispersive X-ray) system with a silicon drift detector at 15 kV, with a working distance of 10 mm. All cycled electrodes were carefully washed with water to remove any electrolyte residue and dried in air before X-ray diffraction (XRD) and SEM analysis.

Zinc-based symmetric cells were tested in 2032 coin cells under galvanostatic conditions at current densities of 1 and 10 mA/cm² with the cutoff charge of 5 mAh/cm². Glass fiber was used as the separator and 0.2 mL of 1M ZnSO₄ (99%, Sigma Aldrich) was used as the electrolyte. Dibenzo[b,i]thianthrene-5,7,12,14-tetraone (DTT) was used as a cathode for the full cell study. Cathode powders of DTT (60 wt %) were mixed with acetylene black (30 wt %) and 10 wt % of polytetrafluoroethylene (PTFE, 60 wt % dispersion in H₂O, Sigma-Aldrich) to fabricate a free-standing thin film using a planetary ball mill machine (Retsch PM 100 CM ball mill). The DTT film was rolled into a thin membrane and vacuum-dried overnight at 120° C. overnight. The dried cathode electrode film was then punched into 0.5-inch diameter disks and pressed onto a titanium mesh current collector. The average mass loading of DTT cathode was approximately 5 mg/cm². Galvanostatic charge/discharge at 0.2 C (0.57 A g⁻¹) from 1.4 to 0.3 V was used for all full cells in these examples, unless otherwise indicated. All electrochemical measurements were made using a Biologic VMP3 multichannel potentiostat (Biologic USA) attached to a PC using EC-Lab Software (v. 11.3).

### Example 1

### Anode Preparation and Characterization

AlZn and InZn alloy anodes were prepared by electrodeposition as described in the Experimental section above, which comprises electrodeposition in the presence of particles that are incorporated into the depositing film via convection. The incorporation of Al₂O₃ into zinc and InZn occurs by precipitation due to the pH shift during electrodeposition (Arakawa et al., Electrochemistry 2017 85(6):315-318).

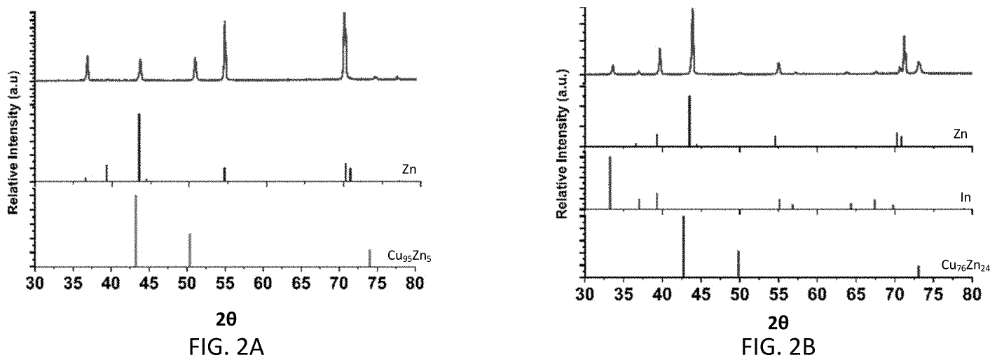

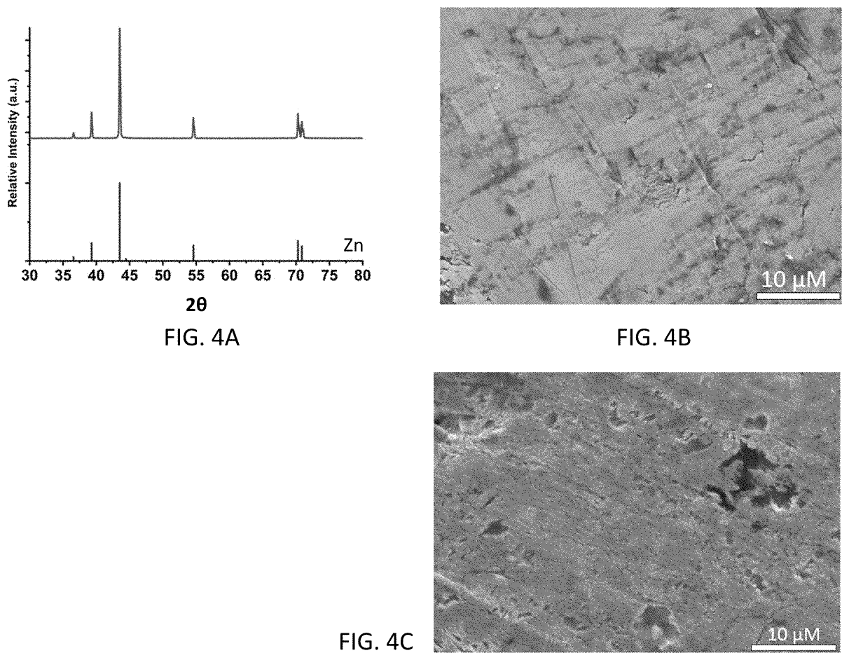

FIGS. 2A-B, 3A-D, and 4A-B show XRD spectra of the electrodeposited AlZn, InZn, and commercial zinc foil. Side-by-side comparison shows that the commercial zinc foil (FIG. 4A) has a prominent (101) lattice plane reflection peak at 43° 2θ (JCPDF #9012435), and near equal texture contributions of the (100), (102), and (103)/(110) reflections. The electrodeposited (ED) AlZn film (FIG. 2A) has the same reflections as the zinc foil, but the relative intensities with the (103)/(110) at 70° and the (102) reflections at 55° are different. There are no evident peaks corresponding to either Al or Al₂O₃ as the concentration of Al₂O₃ is below 1% according to EDS data (vide infra). The InZn alloy presents as two distinct phases (FIG. 2B) with the predominant phases being zinc (JCPDF (Joint Committee on Powder Diffraction Standard) #9012435), and indium (JCPDF #04-007-2066). Zinc and indium have practically zero miscibility, and therefore domains of indium surrounded by zinc exist. Both AlZn and InZn alloys have diffraction peaks of the current collectors (copper and brass, 50° for AlZn alloy indexed to Cu₉₅Zn₅ and 75° for InZn alloy indexed to Cu₇₆Zn₂₄). Zinc has high surface mobility (10⁻⁸ to 10⁻¹⁰ cm² s⁻¹; Cao et al., Physical Review 1941, 59(4):376-381) and will form a surface alloy with Cu during initial stages of electrodeposition.

The surface morphologies of the different anodes are presented in the scanning electron microscopy (SEM) images in FIGS. 3A-3D. Different to the commercial zinc foil (shown in FIG. 4B) having a featureless surface with some macro scratches and defects, the AlZn alloy (FIG. 3A) is composed of hexagonal platelets that are stacked along each other. This is characteristic of electrodeposited zinc. Energy-dispersive X-ray spectroscopy (EDX) analysis (FIG. 3C) shows that it is composed mainly of zinc with aluminum distributed uniformly over the entirety of the surface. The atomic percent of aluminum according to the EDX is less than 1 at %. The low aluminum content is expected as the incorporation of aluminum into the zinc deposit is achieved through a precipitation mechanism. In brief, as the local pH changes during the electrodeposition of zinc, Al₂O₃ is formed that precipitates onto the growing film and then becomes trapped as new layers are formed (Arakawa et al., Electrochemistry 2017 85(6):315-318). The InZn surface (FIG. 3B) shares some similarities with the AlZn in that the majority of the surface is composed of hexagonal platelets. However, the stacking/overlap of these platelets is much more disorderly compared to the AlZn. EDX scanning of the surface (FIG. 3D) shows that the surface is ˜90 at % zinc with 10 at % indium and less than 1 at % aluminum. The Al in the InZn is due to the presence of Al₂(SO₄)₃ in the InZn deposition electrolyte that becomes entrapped in the InZn via the same mechanism as the AlZn. The separated indium phase and surrounded large domains of zinc confirm the separated phases of indium and zinc in the XRD in FIG. 2B.

Transmission-mode SEM (TSEM) analyses of the anodes (FIGS. 5A-5D) were conducted after one dissolution (discharge) at 10 mA cm⁻² to compare with commercial zinc foil (FIG. 4C) after the 1^{st} discharge (Zn dissolution). The zinc foil transformed from a relatively smooth surface (FIG. 2B) to a highly defected surface covered in large pits (FIG. 4C). This in part explains the propensity of zinc foil to form dendrites as the unevenness of the surface aggravates the concentration gradient on the surface in subsequent deposition, resulting in preferential zinc deposition on the higher parts of the surface as a nucleation point compared to the pits. In contrast, the AlZn (FIG. 5A) looked nearly identical to the original surface albeit with some slight roughening. EDX Analysis (FIG. 5C) showed that the composition remains identical to the pristine surface, which was expected as the concentration of aluminum was constant throughout the AlZn film. The InZn featured the starkest change in morphology forming a porous network as shown in FIG. 5B. EDX mapping (FIG. 5D) showed that this network is composed of indium with zinc existing beneath the pore space.

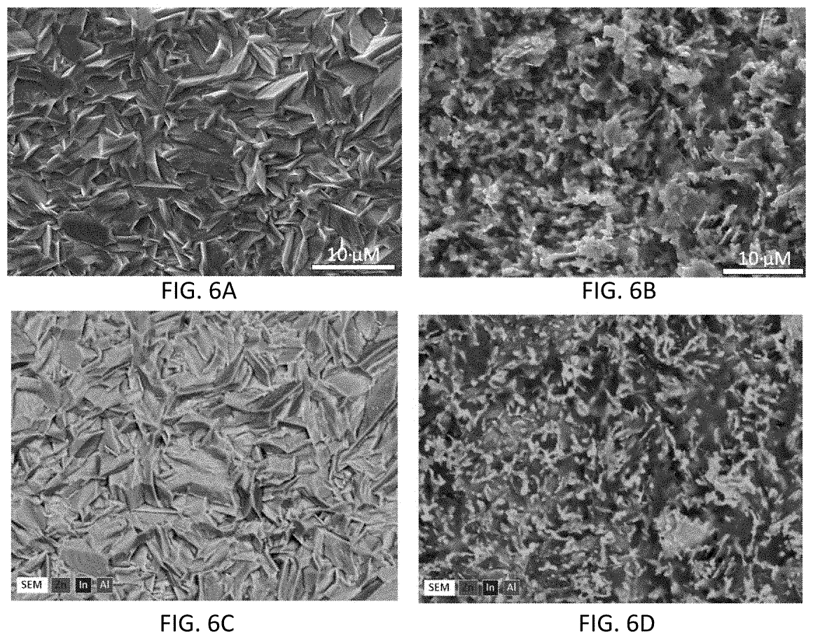

The amount of indium needed to achieve this porosity was studied by altering the indium concentration in the electrodeposition electrolyte. It was found that reducing the indium concentration in the solution by 50% lowered the surface concentration of indium to ˜2-5 at % (vs ˜8-11 at % indium), which does not allow for much porosity to form. FIGS. 6A-6D shown SEM analysis of uncycled InAlZn with 2 at % surface indium (FIG. 6A) and cycled 2 at % InAlZn (FIG. 6B), and EDS mapping of uncycled 2 at % indium in InZn (FIG. 6C) and cycled 2 at % indium in InZn (FIG. 6D). For the anodes of FIGS. 6C and 6D, the electrodeposition electrolyte did not include aluminum sulfate. Increasing the indium concentration in solution by 50% was found to slightly increase the surface indium concentration (˜12 at %), however cyclability was poor due to the bulk containing 30 at % indium (FIGS. 7A-7F). It was determined that an initial surface concentration ranging from 9.5 at % to 12 at % on the surface, which corresponds to a bulk concentration ranging from 10 at % to 15 at % indium, provided superior results in particular examples. As seen in FIGS. 7D-7F, the first layer to deposit on the current collector is zinc, and then competitive deposition of zinc and indium occurs. Since indium is more favorable for deposition, the concentration of indium is higher in the lower portion of the deposited zinc-rich alloy relative to the overall indium concentration of the alloy.

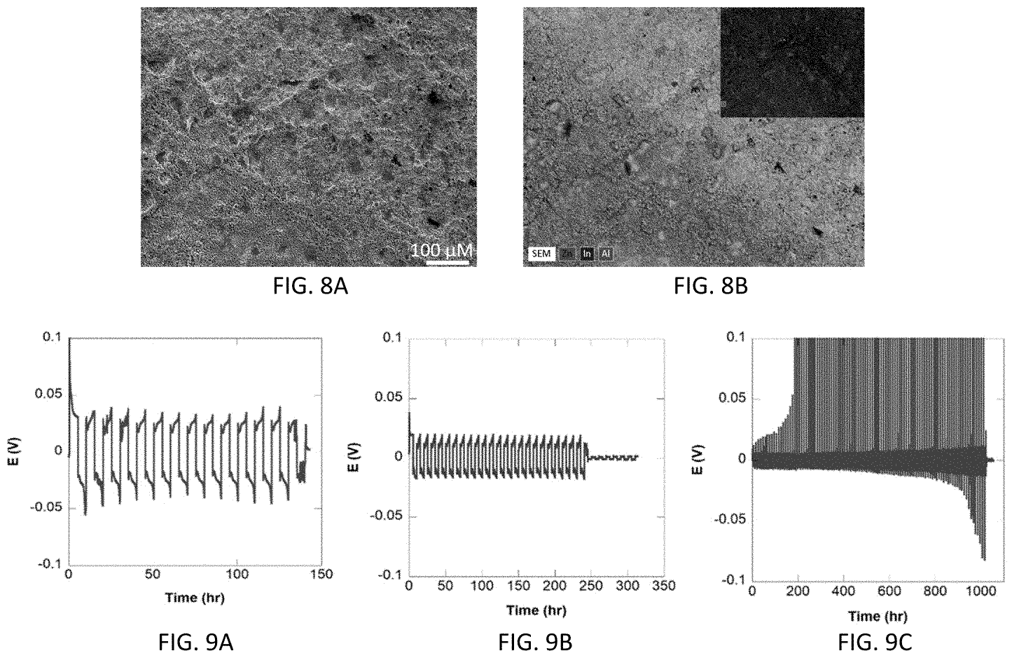

Upon de-alloying, the more noble constituent, indium, remained and rearranged/oxidized to provide a porous network. It is also consistent with formation of an In₂O₃ layer formed discharge of the galvanically exchanged indium-rich InZn, which allowed for the diffusion of zinc through the indium layer upon subsequent charging. This was evidenced in low magnification EDX of the surface (FIG. 8B) in which higher oxygen concentration was observed in the indium-rich regions of the de-alloyed surface.

### Example 2

### Cells with InZn Anodes

Symmetric cells were employed to assess the feasibility of using the electrodeposited alloys as anodes of aqueous zinc batteries. The alloy zinc anodes were tested with practical capacity limited to 5 mAh cm⁻² and an appropriate current density range between 1 mA cm⁻² and 10 mA cm⁻² (˜0.1 C-1 C). These testing conditions were chosen because the cathode loading for a practical zinc cell will generally be between 5-10 mAh cm⁻² and the anode loading should be approximately 20% higher, resulting in anode loadings ranging from 6 mAh cm⁻² to 12 mAh cm⁻². The applied current to such a cell will be in the range of 0.5 mA cm⁻² to 20 mA cm⁻² (0.1 C to 4 C) depending on the cathode loading and use case.

FIGS. 9A-9C show the commercial zinc foil, AlZn anode, and InZn anode being cycled at a current density of 1 mA cm⁻² with a corresponding charge of 5 mAh cm⁻². The charge of 5 mAh cm⁻² corresponds to a depth of discharge (DOD) of 2.9% and 45% for the zinc foil and electrodeposited anodes, respectively. Zinc foil exhibited a polarization ranging from 30 mV to 40 mV, which was the highest of the anodes at the given current density compared to ˜20 mV for AlZn alloy and ˜5 mV for InZn alloy. Additionally, the commercial zinc foil was the least stable as the cell shorts after 130 hours as shown in FIG. 9A. The AlZn anode (FIG. 9B) had longer cycle life reaching 225 hours. The InZn anode not only exhibited the lowest cell polarization but also the longest cycle life of 1000 hours (FIG. 9C). It should be noted that asymmetric spikes in the polarization were observed in experiments where the loading of the electrodeposited samples was lower compared to the targeted loading. One possibility is that the asymmetric spikes are associated with the high capacity moved during the cycling. Additional possibilities are due to an accumulation of indium on the surface that changes the potential of the anode from that of pure zinc to that of an indium rich surface and/or exposure of the current collector due to uneven dissolution of the material.

Results of the anodes tested at high current density of 10 mA cm⁻² are shown in FIGS. 10A-10C. FIG. 10A shows that zinc foil polarization increased to ˜80 mV coupled with a decrease in stability as the cell shorted after ˜90 hours. The AlZn anode (FIG. 10B) polarization increased to ˜40 mV with the cell durability remaining similar at 310 hours. The polarization of AlZn anodes increased asymmetrically after 200 hours to over 100 mV, which may be attributable to uneven dissolution of the AlZn causing exposure of the Cu current collector. FIG. 10C shows the InZn symmetric cell, which exhibited an initial cell polarization of ˜30 mV that increased at 500 hours due to buildup of indium on the surface of the electrode. However, even with the increase in polarization, the InZn cell demonstrated noticeably substantial tolerance to cell shorting with a long cycle life of over 700 hours at a current density of 10 mA cm⁻². As shown in FIGS. 11A and 11B, anodes with indium concentrations greater than 15 at %, FIG. 11A) or less than 5 at % (, FIG. 11B), exhibited a shortened cycle life compared to the InZn anode of FIG. 10C.

The InZn anodes were further assessed in full cells paired with DTT cathodes in 2 M ZnSO₄. These full cells with various anodes (Zn foil, AlZn, and InZn) had similar charge/discharge curves, and FIG. 12A shows a typical charge/discharge curve of DTT with zinc foil. The discharge plateau at ˜0.75V and charge plateau at ˜0.99V is attributed to the insertion and extraction of H⁺ in the DTT structure (Wang et al., Adv. Mater. 2020, 32(16):2000338). The full cells with AlZn and InZn anodes showed similar cycling stability to that with commercial zinc foil anode (FIG. 12B), indicating that both the AlZn and InZn function comparably to zinc foil, albeit with better tolerance to the formation of dendrites as shown in symmetric cell testing. The capacity difference between the zinc foil (150 mA g⁻¹) and the electrodeposited anodes (130 mA g⁻¹ AlZn vs. 110 mA g⁻¹ InZn) might be ascribed to the alloying elements changing the anode potential slightly compared to pure zinc, and/or to the cathode loading. The AlZn and InZn anodes had slightly higher loadings (6 mg cm⁻²) than the zinc foil cell (5 mg cm⁻²), which yield lower capacities until the cathode is fully wetted.

The InZn anode exhibited better dendrite mitigation and electrochemical performance than the AlZn alloy mainly due to the controlled indium doping enabling the formation of a unique porous structure during de-alloying. Without wishing to be bound by a particular theory of operation, the indium domains rearrange during dealloying to form connected walls of a porous structure and the structure is stabilized after forming oxides on the surface. The porous structure formation is related to the indium level. The results shown in FIG. 8B are from an anode with 10 at. % indium. The porous structure mostly disappeared with lower indium concentration of 2 at % (FIGS. 6A-6D) because the Al₂O₃/Zn alloy formed via electrodeposition could not reach a sufficiently high indium concentration in the surface portion to form a porous structure. Notably, commercial zinc particles doped with indium at very low concentrations (e.g., 300 ppm, <1.7 at % indium) to minimize gassing do not form a porous structure when cycled (FIGS. 13A, 13B).

The results demonstrate that InZn anodes with zinc domains surrounding indium domains form a porous structure to mitigate dendrite formation and deliver long cycling stability at high-capacity utilization and high current density. The InZn alloy anodes exhibited much lower polarization in the symmetric cells with zinc foil or AlZn anodes. Compared to many nano-synthetic routes that consumes high energy, electrodeposition is cost efficient, has a high yield, tunable, and is easily scalable.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. An anode, comprising an InₓM_{y}Zn_{z} alloy, wherein:
M is Al, Ag, Bi, Pb, Sn, Cd, or any combination thereof; and
when the anode has not been previously cycled,
x ranges from 0.03 to 0.20;
z ranges from 0.83 to 0.97;
x+y+z=1;
the anode comprises indium domains and zinc domains distributed throughout the InₓM_{y}Zn_{z} alloy; and
an exposed upper surface of the anode has a zinc concentration ≥z.

2. The anode of claim 1, wherein:
x ranges from 0.08 to 0.12;
0<y≤0.02; and
z ranges from 0.86 to 0.92.

3. The anode of claim 1, further comprising a current collector.

4. The anode of claim 3, wherein the anode further comprises a zinc layer in contact with the current collector, the zinc layer having a thickness of 0.5 μm to 1 μm.

5. The anode of claim 3, wherein a concentration of indium in a lower region of the InₓM_{y}Zn_{z} alloy proximal to the current collector is >x.

6. The anode of claim 1, wherein, in a partially or fully discharged state after one or more cycles, the anode comprises:
a porous surface portion comprising a plurality of pores, the porous surface portion having an indium concentration greater than x at % and a zinc concentration less than z at %; and
a bulk portion comprising the InₓM_{y}Zn_{z} alloy.

7. The anode of claim 6, wherein the porous surface portion comprises at least 50 at % indium in the fully discharged state.

8. The anode of claim 7, wherein the porous surface portion comprises at least 75 at % indium in the fully discharged state.

9. The anode of claim 6, wherein the porous surface portion comprises In₂O₃.

10. The anode of claim 6, wherein pores of the porous surface portion are at least partially filled with zinc when the anode is subsequently in a partially or fully charged state.

11. The anode of claim 10, wherein, a morphology of the indium in the porous surface portion remains static as pores fill with zinc during a charging process and empty during a subsequent discharging process.

12. The anode of claim 1, wherein the anode has:
(i) a polarization ranging from 5 mV to 45 mV; or
(ii) an areal capacity of at least 1 mAh cm⁻²; or
(iii) a specific capacity of at least 500 mAh g⁻¹; or
(iv) any combination of two or more of (i), (ii), and (iii).

13. The anode of claim 1, wherein M is Al.

14. A rechargeable zinc cell, comprising:
an anode according to claim 1;
a cathode; and
an aqueous electrolyte.

15. The rechargeable zinc cell of claim 14, wherein the cathode comprises dibenzo[b,i]thianthrene-5,7,12,14-tetraone, pyrene-4,5,9,10-tetraone, triangular phenanthrenequinone-based macrocycle, tetrachloro-1,4-benzoquinone, tetraamino-p-benzoquinone, 3,4,9,10-perylenetetracarboxylic diimide perylenediimide perylimid, 3,4,9,10-perylenetetracarboxylic dianhydride, phenazine, diquinoxalino [2,3-a:2′,3′-c] phenazine, polyaniline, polypyrrole, poly-thiophene, poly(3,4-ethylene dioxythiophene), poly(p-phenylene), polyindole, a nitronyl nitroxide, an organosulfur polymer, triphenylamine, a triphenylamine derivative, MnO₂, vanadium oxide, ZnₓMn₂₋ₓO₄ where x≤1, MnS, Co₃O₄, Ag, MgV₂O₅, Bi₂S₃, calcium vanadium oxide, a manganese-based metal organic framework, a copper-based metal organic framework, Prussian blue, or a Prussian blue analogue.

16. The rechargeable zinc cell of claim 14, wherein the aqueous electrolyte comprises ZnSO₄, Zn(H₂NSO₃)₂, Zn(CH₃SO₃)₂, Zn(C₂F₆NO₄S₂)₂, Zn(F₂NO₄S₂)₂, Zn(ClO₄)₂, and Zn(CH₃CO₂)₂, or any combination thereof.

17. A method of making an anode according to claim 1, comprising preparing a film comprising the InₓM_{y}Zn_{z} alloy via electrodeposition from an aqueous solution comprising In³⁺ ions and Zn²⁺ ions in an In:Zn molar ratio of x:z.

18. The method of claim 17, wherein the aqueous solution comprises In₂(SO₄)₃ and ZnSO₄.

19. The method of claim 17, wherein the film is electrodeposited onto a current collector.

20. The method of claim 17, wherein the aqueous solution further comprises aluminum sulfate and boric acid.
